(19) United States
(12) Patent Application Publication
(10) Pub. No.: US 2002/0026343 A1
(43) Pub. Date: Feb. 28, 2002

(54) Material and labor cost estimatting method and system

(76) Inventor: Dennis Duenke, St. Louis, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/925,399

(22) Filed: Aug. 9, 2001

Related U.S. Application Data
(60) Provisional application No. 60/223,963, filed on Aug. 9, 2000.

(51) Int. Cl. G06F 17/60

(52) U.S. Cl. 705/8

(57) ABSTRACT

A material and labor cost estimating method and system for estimating the construction costs related to mechanical contracting, electrical contracting, fire protection or processing businesses. The method and system utilizes databases of construction material items, graphical representations of the items, material and labor costs, and a data entry screen to estimate a construction project. Groups of items that comprise a Typical system being installed may be defined to include all the related equipment and hook-ups to install the Typical system. The group of items may also be graphically displayed to illustrate the connection of the equipment to a main construction line. The estimated construction costs may be calculated upon selection of construction items.

### BACKGROUND OF INVENTION

1. Field of the Invention

The present invention generally relates to a method and system for determining the exact counts of construction hardware and associated material and labor costs for estimating construction projects. More particularly, the invention pertains to on-screen tools and instructions which walk a user through identifying construction items for a specific construction project. Once data is entered, automated procedures produce total estimated material costs, labor hours, units of measure and costs for a project.

2. Description of Related Art

Computer-based cost estimating programs have long been used in business to calculate material and labor costs for projects. They have also been used for purposes of looking up material and labor costs. Conventional models have also been expanded to be useable to track the material and labor costs of projects.

The advantages of such computerized programs include reduction of manual errors, a decrease in estimating turn-around time as well as extended capabilities beyond those which can be carried out on a manual or a semi-automated basis. More recent programs implement WINDOWS-based programs using a mouse and digitized boards. WINDOWS is a registered trademark of Microsoft, Inc. (Redmond, Wash.).

Such programs make it possible to generate material and labor cost estimates for mechanical piping, electrical systems, control devices, supports and structural steel, sheet metal and insulation, fire protection systems, industrial process lines and the like. Some of these systems can also be used for scheduling of manpower and materials to build a project.

Programs of the prior art, however, do not permit an individual to visually observe the location of a given piece of hardware in relation to connected hardware, equipment, or fixtures when conducting an estimate. Prior art programs have displayed a standardized list of hardware quantities in tabular form that the user can manipulate to suit a customized project. The user must exercise skill in selecting components for the estimate. Errors in estimating are often easily overlooked as an estimator views a table of numbers representing the quantity of hardware that is to be used rather than graphically viewing the location of where the hardware will be installed.

While prior art methods and software programs have been used to estimate labor and material for construction projects, they are time consuming, difficult to understand, and/or require a long learning curve. When such a method or program is learned, even if it is simple to use, if it is not used very often, it becomes quickly forgotten.

It would therefore be beneficial to have an estimating program that permits a user to view graphical representations of the installation locations of equipment and connection or “hook-up” hardware and thereby reduce erroneous ordering of incorrect or unnecessary hardware. It would also be useful for all the items required for a to install equipment identified in the graphical representation could be grouped together as a single group and added to an estimate as a group. It would be further beneficial to have an estimating program that overcomes the learning difficulties of the prior art by providing a data entry screen which looks similar to a manual take off sheet used in construction estimating, in which estimating data can be graphically entered and viewed. It would be further useful for the program to display messages that guide the user through the program in a manner that reduces erroneous data from being entered.

### SUMMARY OF THE INVENTION

Accordingly, it is an object of the present invention to provide a material and labor cost estimating method and system which provides an individual with graphical illustrations identifying the equipment that is the subject of the estimate.

Another object of the present invention is a mechanical cost estimating method and system that provides graphical illustrations of equipment and identification of the detailed connections to be estimated.

Another object of the present invention is a mechanical cost estimating method and system that provides a user with prompting instructions regarding appropriate data that should be entered at various steps in data entry.

A further object of the invention is a mechanical cost estimating method and system that provides a user with all the items required to install equipment and hook-up materials of a construction project that are grouped together as a single group and added to an estimate as a group.

Still another object of the present invention is a mechanical cost estimating method and system that provides a graphical user interface data entry screen in a take off sheet.

Briefly, therefore, the present invention is directed towards a computerized method for estimating material and labor costs of a construction project. The method comprises maintaining a database of items and cost data associated for the items, grouping one or more of the items to define predetermined sets of grouped items, selecting one or more of the grouped items based on the construction project, and calculating the estimated cost of the construction project based at least in part upon the cost data associated with the items in the selected set of grouped items.

In another aspect, the invention is directed to an automated material and labor cost estimating method within a computer system having a processor, a graphical user interface including a computer display, and an input device. The method comprises maintaining a database of items and cost data associated with the items. One or more of the items are grouped to define predetermined sets of grouped items corresponding to a desired installation of the construction project. A Take Off Sheet data entry screen is displayed comprising quantity data cells corresponding to item size. One or more of the grouped items are entered onto the Take Off Sheet based on the construction project. The estimated cost of the construction project is calculated based at least in part upon the identified quantities of items.

In another aspect, the present invention is directed to an automated system for estimating a cost of selected equipment for a construction project. The system comprises a first database containing construction items and material and labor cost data associated with the construction items and a second database containing predetermined sets of grouped items corresponding to a desired installation of the grouped items in the construction project. A computer executes a cost estimating software program that accesses the second database and provides a cost estimate of the construction project based at least in part upon the selected grouped items data.

In yet another aspect, the present invention is directed to a computerized system for estimating the material and labor costs of a construction project. The system comprises a remote server on a communications network managing software programs and databases, a central database associated with the remote server storing construction material specifications and graphics, labor cost data, and material prices, and a local computer on a communications network. The local computer executes an estimating software program and accessing data from the central database and generating material and labor costs for the construction project.

Other features of the present invention will be in part apparent to those skilled in the art and in part pointed out in the detailed description provided below.

### BRIEF DESCRIPTION OF DRAWINGS

FIG. 1 is a block diagram invention of a mechanical cost estimating system according to a preferred embodiment of the invention.

FIG. 2 is a block diagram illustrating interrelationships between data entry, data entry screens, material databases, and reports databases used by the system of FIG. 1.

FIG. 3 is an exemplary flowchart illustrating data entry operations of the system of FIG. 1.

FIG. 4 is an illustration of an exemplary Copy Down Utility user interface according to a preferred embodiment of the present invention.

FIG. 5 is an illustration of an exemplary Take Off Sheet data entry user interface according to a preferred embodiment of the present invention.

FIG. 6 is an illustration of an exemplary item drop-down user interface for selecting an item according to a preferred embodiment of the present invention.

FIG. 7 is an illustration of an exemplary window user interface displaying a graphical representation of an item selected from a Take Off Sheet and “Next Step Messages.”

FIG. 8 is an illustration of an exemplary “Pick a Starting Size” window user interface according to a preferred embodiment of the present invention.

FIG. 9 is an illustration of an exemplary window user interface showing “size buttons” according to a preferred embodiment of the present invention.

FIG. 10 is an illustration of an exemplary calculator window user interface according to a preferred embodiment of the present invention.

FIG. 11 is an illustration of an exemplary pipe material and labor calculator window user interface according to a preferred embodiment of the present invention.

FIG. 12 is an illustration of an exemplary Typical list drop-down list user interface according to a preferred embodiment of the present invention.

FIG. 13 is an illustration an exemplary HVAC “Typical” being created in the Typical Image and Attribute Builder according to a preferred embodiment of the present invention.

FIG. 14 is an illustration an exemplary “Options” window user interface according to a preferred embodiment of the present invention.

FIG. 15 is an illustration an exemplary plumbing “Typical” being created in the Typical Image and Attribute Builder according to a preferred embodiment of the present invention.

FIG. 16 is an illustration an exemplary coupled HVAC “Typical” being created in the Typical Coupling Creator according to a preferred embodiment of the present invention.

FIG. 17 is an illustration an exemplary coupled plumbing “Typical” being created in the Typical Coupling Creator according to a preferred embodiment of the present invention.

FIG. 18 is an illustration an exemplary HVAC “Typical” in a Typical Builder Items screen according to a preferred embodiment of the present invention.

FIG. 19 is an illustration an exemplary item drop-down box user interface according to a preferred embodiment of the present invention.

FIG. 20 is an illustration of an exemplary “Replace Utility” user interface in accordance with the present invention according to a preferred embodiment of the present invention.

FIG. 21 is an illustration of an exemplary “Print Utility Screen” user interface in accordance with the present invention according to a preferred embodiment of the present invention.

FIG. 22 is an illustration of an exemplary “Updatable Grid” user interface in accordance with the present invention according to a preferred embodiment of the present invention.

### DETAILED DESCRIPTION OF THE PREFERRED EMBODIMENTS

The present invention provides systems and methods that assist in determining the amount of labor and material to produce an estimate for construction projects. The present invention overcomes the learning difficulties of the prior art by providing a data entry screen which looks similar to a manual take off sheet used in construction estimating, but which is linked to a database and utilizes step by step messages to help the user remember how to use the program. In addition, the present invention incorporates features to speed up data entry, view estimate data on a screen, compile estimate data to reports, and update databases and pricing.

The present invention comprises a computer, processor, display, data storage device, graphical user interface, data entry screen (e.g., the Take Off Sheet), graphical illustrations of equipment, graphical illustrations of connection hardware, a project specific database of saved estimate data, pricing databases, report programs, and a messaging feature that walks a user through data entry.

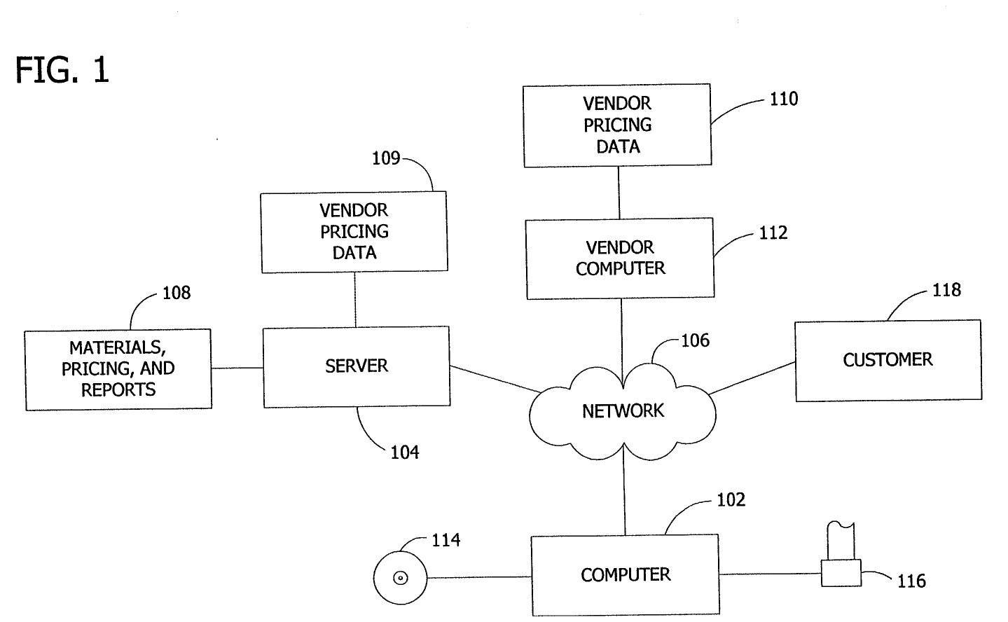

While this invention is susceptible of embodiment in many different forms, FIGS. 1-22 illustrate specific embodiments thereof with the understanding that the present disclosure is to be considered as an exemplification of the principles of the invention and is not intended to limit the invention to the specific embodiments illustrated.

Referring now to the drawings, FIG. 1 illustrates an exemplary physical configuration of a mechanical cost estimating system 100 embodying aspects of the present invention. In FIG. 1, computer 102, such as a personal computer, workstation, notebook computer, and the like accesses computer server 104 via network 106. Network 106 may be any computer network such as an intranet (e.g., a local area network, wide-area network, and the like), or a global computer network (e.g., the Internet). Computer 102 may contain material and labor cost estimating software, databases for materials, pricing, reports, and other databases stored locally in its own memory, hard drive, compact disk drive, or other storage device. Once the material and labor cost estimating software is executed, the materials, pricing, and reports databases are updated from materials, pricing, and reports data 108 and vendor pricing data 109 accessed by server 104. Materials, pricing, and reports data 108 and vendor pricing data 109 are downloaded to computer 102, via network 106, for utilization in mechanical cost estimating software.

Alternatively, computer 102 may access vendor pricing data 110 directly from vendor computer 112 via computer network 106. Vendor pricing data 110 is preferably downloaded to computer 102 for utilization in mechanical cost estimating software.

Still alternatively, materials, pricing, reports, and vendor data may be updated directly from a computer readable disk 114 (e.g., compact disk, magnetic diskette, etc.) containing stored estimating data that is accessed locally by computer 102.

Computer 102 may also alternatively use a browser to access and execute the mechanical cost estimating software located remotely on server 104 via computer network 106. In such a system, vendor may be updated from server 104, vendor computer 112, locally from a computer readable disk 114, or accessed directly from sever 104, as described above.

Once all of the databases have been established and updated, computer 102 executes the material and labor cost estimating software to generate material and labor cost estimate reports are generated. The material and labor cost estimate reports may be output to the display screen of computer 102, to printer 116 or a remote printer via network 106, to an export file that is stored locally on computer 102 or remotely on server 104, or sent directly to customer 118, via network 106, in the form of a computer file, an email, facsimile, and the like.

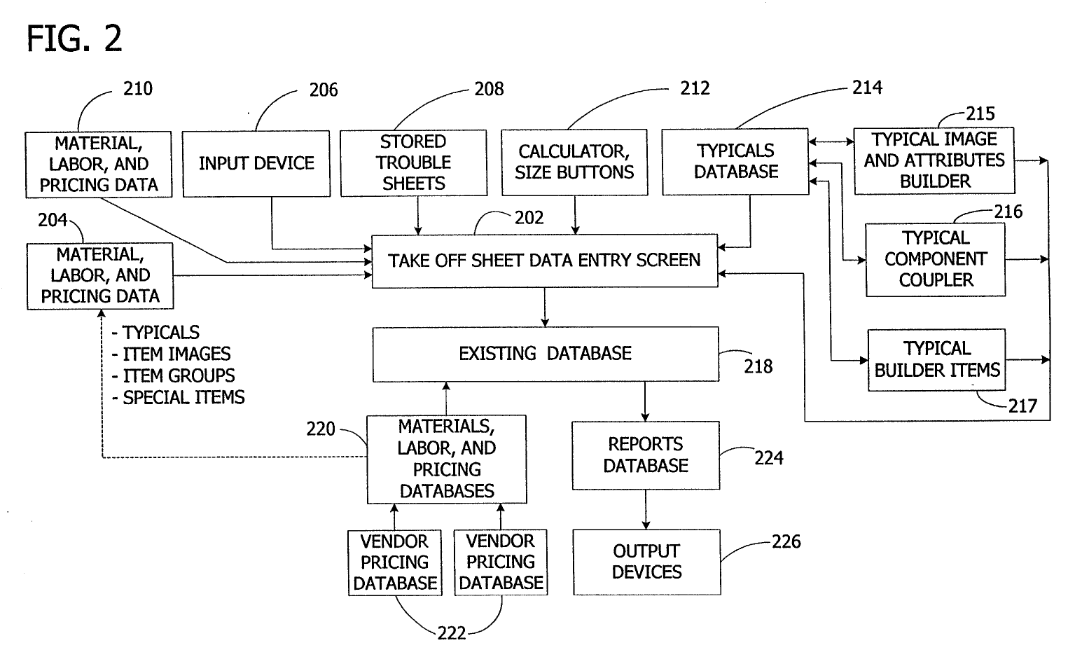

FIG. 2 is a block diagram illustrating the interrelationships between data entry, data entry screens, material databases, and reports databases for a preferred embodiment of the present invention. The present invention shows a graphical user interface that includes a data entry screen. In this instance, an estimating take off sheet data entry screen 202 (hereinafter referred to as “Take Off Sheet”) is supplied data by user defined descriptions 204, input device 208, stored Take Off Sheets 210, material, labor, and pricing databases 206, calculator and size windows 212, Typical Builder Items 214, Typical Image and Attributes Builder 216, and Typical Component Coupler 216. User defined descriptions 204 comprises systems and materials definitions, item images, and item groups set up by a user for a project being estimated. Take Off Sheet 202 also provides function buttons, boxes, and menus which permit a user to manipulate data and calculate estimates such as multiply quantities, show messages, calculate buttons and boxes and the like. Input device 206 comprises a computer mouse, roller ball, trackpad, pointer, digitizer, touch screen, and the like. Stored takeoff sheets 208 comprise previous takeoff sheets created and saved to estimating database 218. Material, labor, and pricing databases 210 comprise material specification, material cost, labor cost, vendor pricing databases and the like utilized to identify the specifications and material and labor costs associated with an item used or installed in a construction project. An item may be selected from material, labor, and pricing databases 210 by utilizing computer pull-down menus provided by Take Off Sheet 202. Calculator and size buttons 212 comprise graphical user interface windows displayed on a computer screen from which numerical quantities and sizes may be entered onto Take Off Sheet 202. Calculator and size buttons 212 also access information from material, labor, and pricing databases 210 which identify whether a specific item is available. Typicals Database 214 contains saved groups of items and quantities of items (hereinafter referred to as “Typicals”) that are represented by graphical images of fixtures or equipment and associated hook-up material (pipes, ductwork, connectors, electrical wiring, etc.) that connect the fixtures or equipment to a main line. Thus, Typicals constitute predetermined sets of grouped items corresponding to a desired combination or installation wherein the items include fixtures, equipment and associated hook-up material. The saved Typicals may be accessed later and entered into Take Off Sheet 202. Typical Image and Attributes Builder 215 is a computer application that permits a user to create Typicals and enter the groups of items and item quantities defined in a Typical directly to Take Off Sheet 202 or alternatively, save the Typicals to Typical Database 214. Typical Component Coupler 216 connects Typicals together that were defined by Typical Image and Attributes Builder 215 or modified by Typical Builder Items 217 and sizes the coupling connections according to information in building code databases and available item sizes in size databases. The coupled Typical can be entered directly to Take Off Sheet 202 or alternatively, saved to Typical Database 214. Typical Builder Items 217 modifies items and/or item quantities in Typicals defined by Typical Image and Attributes Builder 215 or Typical Component Coupler 216 and enters the modified Typicals directly to Take Off Sheet 202 or alternatively, saves the Typicals to Typical Database 214.

Once data has been entered onto Take Off Sheet 202, the information is manipulated according to a specific construction project estimate and saved to estimating database 218 as a specific takeoff sheet record. Estimating database 218 also accesses information from materials and labor databases 220 which, in turn receives pricing data from vendor databases 222. Materials and labor databases provide estimating database 218 with specific material and labor units associated with items used in a construction project. When a project is calculated, material and labor units are associated with all items for a sheet or group of sheets, are totaled, and cost estimates are calculated. The cost estimates are formatted on a report form from reports database 224 and output to output devices 226. Output devices 226 may include any form of output device used to view or access a report, including a printer, a display screen, an export file, email, facsimile, and the like.

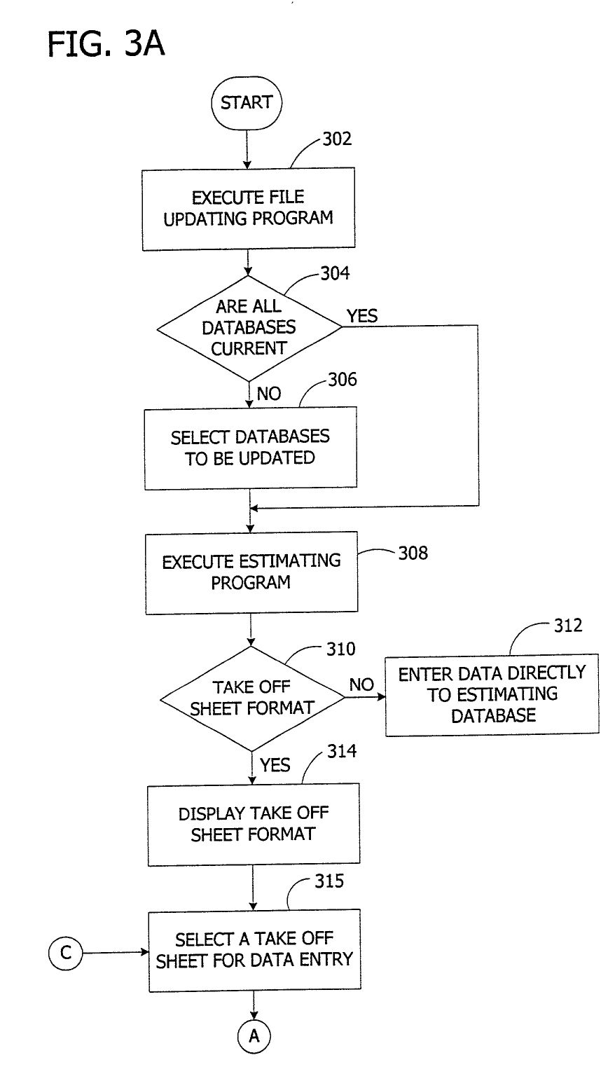

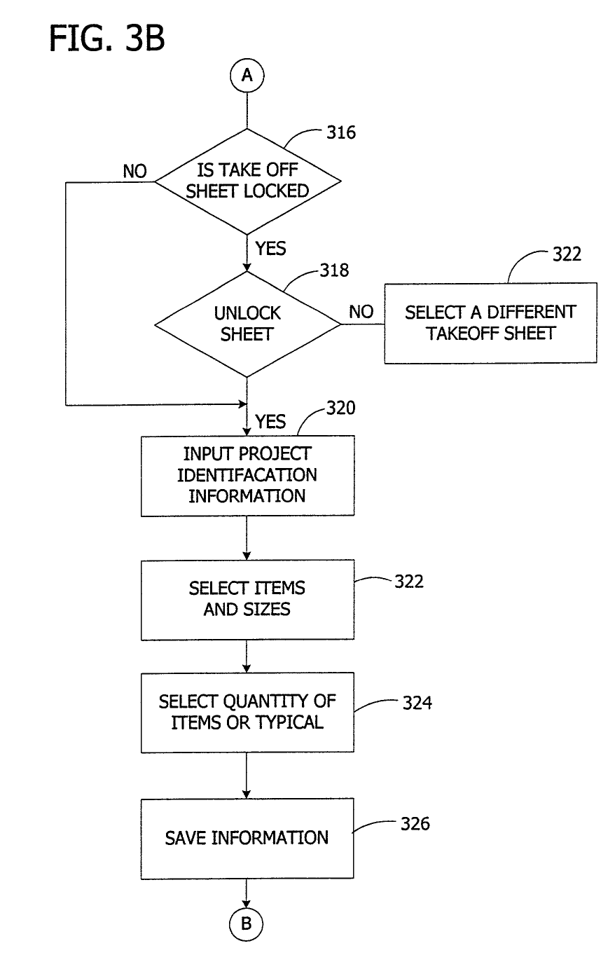

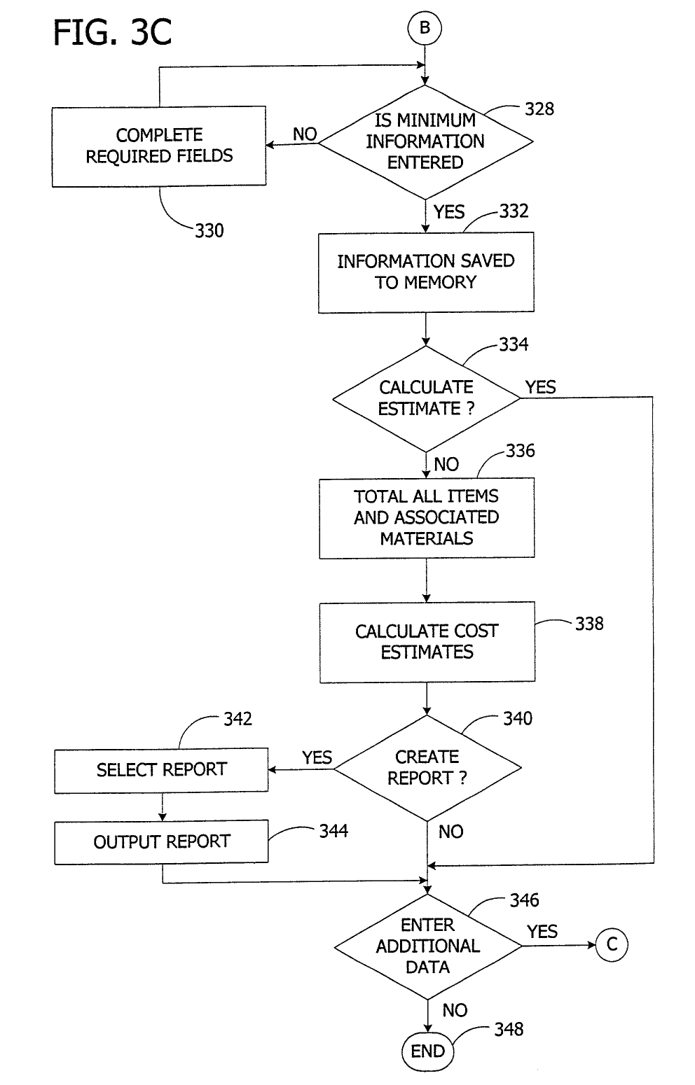

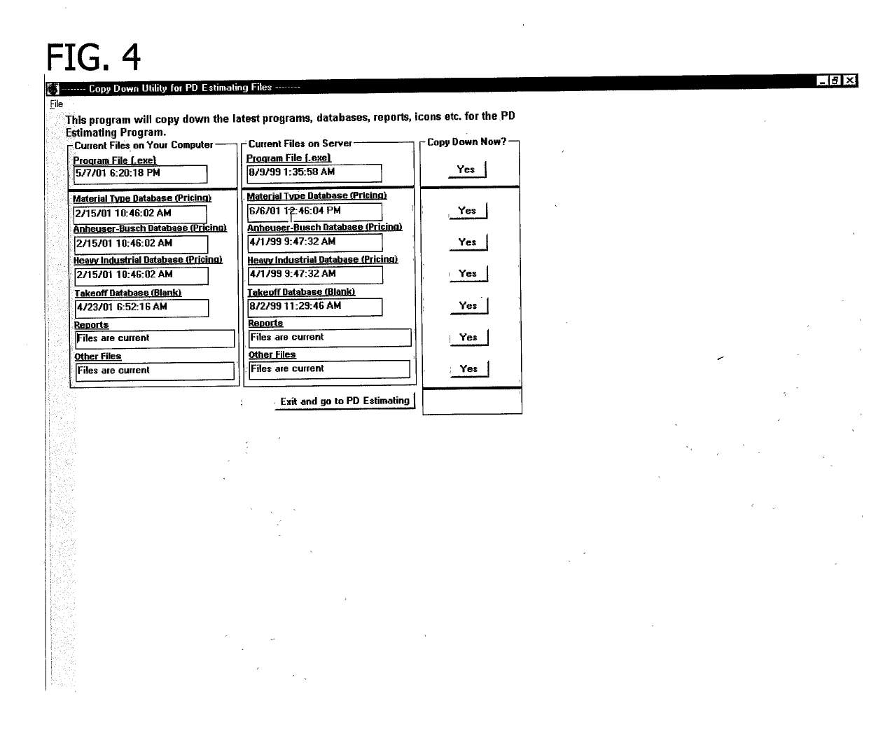

FIG. 3 is an overview flowchart of the mechanical cost estimating process. The process begins at step 302 with the execution of a file updating program (hereinafter referred to as the “Copy Down Utility”) which keeps track of all the programs, reports, and files associated with the program. The Copy Down Utility compares the master databases and files that are present on server 104, CDROM, or other storage device with local databases such as the vendor pricing, materials, project, take off, reports and other files and databases stored locally on computer 102 and determines whether the local files are up to date. If any local file is not current, the user may replace the older local file with the newer file from server 104, CDROM, or other storage device. For example, if all master files are stored on server 104, when a user of the present invention uses the Copy Down Utility program while on computer network 106, the program compares all the dates and times of each local file accessed by computer 102 to the files on server 104. The Copy Down Utility at step 304 identifies which local databases or files are not current with the databases or files residing on server 104. At step 306, if any file has a newer date and time on server 104 compared to the local file(s) on computer 102, the user is given a choice whether to download the databases which are not current. An exemplary Copy Down Utility screen is illustrated in FIG. 4.

In addition to maintaining all the files associated with the estimating program, the Copy Down Utility may itself be periodically updated and maintained through the estimating program from the file menu. A text message and instructions may be displayed indicating that the Copy Down Utility program is not current and needs to be updated.

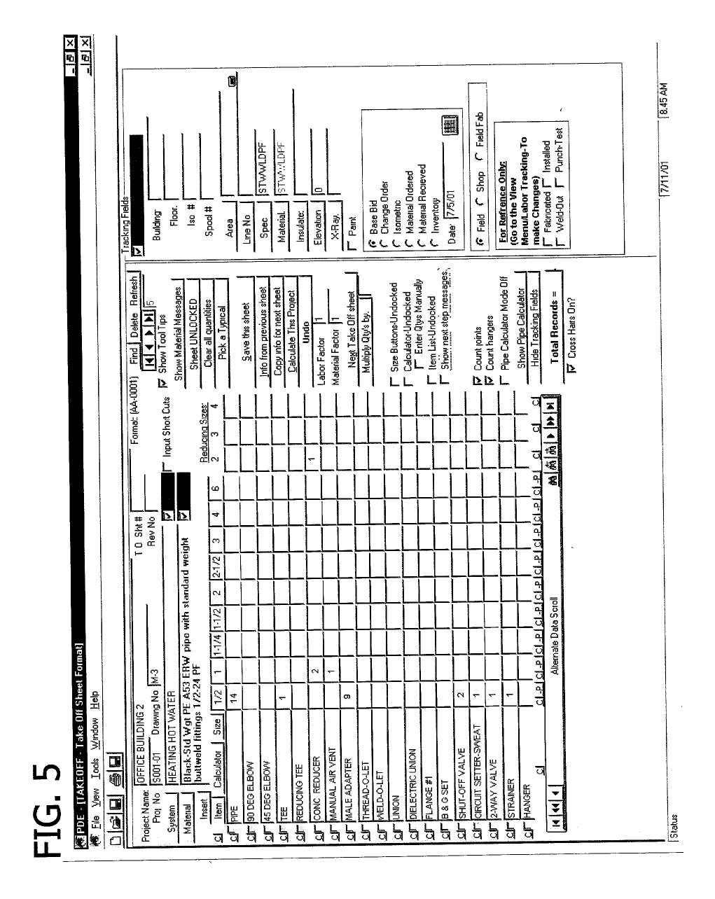

At step 308, the estimation program is executed. The user is asked whether they want to work on a new project, an existing project, or the last project on which the user worked. The user selects the desired project option. At step 310, the user selects to use a “database format” or a “Take Off Sheet” format for inputting estimate data. If the database format is selected, at step 312, the user enters data directly into estimating database 218. If the Take Off Sheet format is selected, at step 314, a Take Off Sheet data entry screen, as illustrated in FIG. 5, is displayed on the screen of computer 102. The Take Off Sheet contains rows of items and columns of either item sizes or item reducing sizes. A data cell exists at each column and row intersection wherein a quantity value corresponding to the quantity of items of a given size or reducing size is entered. The default Take Off Sheet may be blank, it may be the last sheet the user was estimating, or it may be some other default sheet. At step 315, the user selects the desired Take Off Sheet for data entry.

Messages (hereinafter referred to as “Next Step Messages”) are optionally displayed on top of the Take Off Sheet entry screen. The Next Step Messages point to an entry cell or button that would be the next logical step where data should be entered or an activity performed and also displays a message describing what the nature of the next step should be. The Next Step Messages may be optionally disabled.

When the user selects a cell to enter data, the Take Off Sheet is checked to determine whether it is locked or unlocked at step 316. For data protection purposes, Take Off Sheets may be locked once they have been saved to prevent inadvertent overwriting of data. If the sheet is locked, at step 318 the system warns the user that entry of data will overwrite existing data on the Take Off Sheet and asks whether the user wants to overwrite the data, and thereby unlock the sheet. If the user chooses to overwrite the data, the process proceeds to step 320. If the user does not want to overwrite the data, the user may select a different Take Off Sheet at step 322 from the database and the process proceeds to step 316.

At step 320 the user may enter project identification data such as project name, project number, drawing number, system, material, building, Take Off Sheet number, Take Off Sheet revision number, and the like. This information may be preset in a database which can be selected by the user from a computer drop-down box, automatically completed upon entry of the first few characters of typed data, manually typed in its entirety into the data box, and the like. The project identification information is utilized by the program to save the individual Take Off Sheet as well as group the Take Off Sheet with related projects for estimating the costs for an entire project of several systems. A system identifies the type of system being estimated such as chilled water, hot water, domestic water, sanitary waste and vent, electrical system, process systems, high pressure supply air, or other system to be installed. Several types of materials may be required for the installation of each system, such as carbon steel, carbon steel, copper, stainless steel or other type of pipe or conduit material.

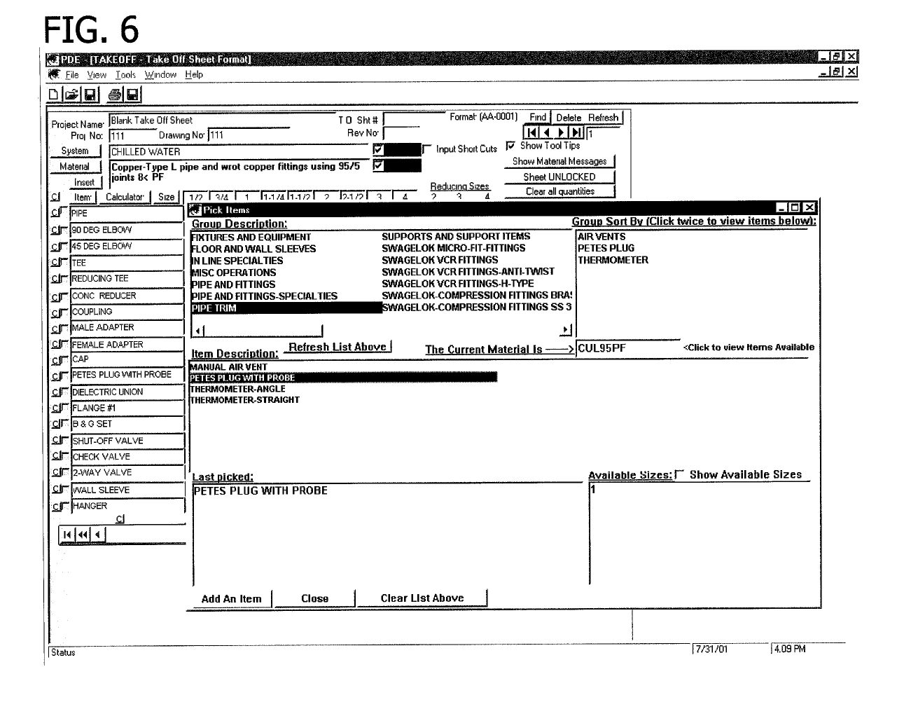

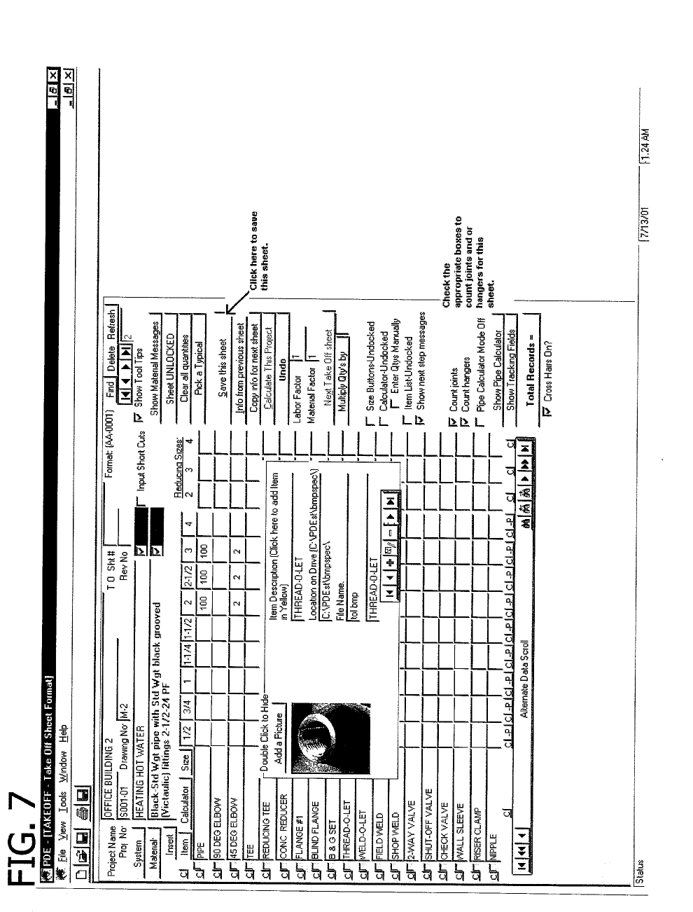

After project identification data have been entered, at step 322 specific items such as a pipe, elbow, coupling and the like may be entered and the corresponding size(s) and quantity or quantities may be entered into data cells of the Take Off Sheet that are required for the project being estimated. Take Off Sheet item text boxes and data cells may be selected by highlighting, clicking a mouse button, and so forth to bring up either a hardware item selection list, item size buttons, or a calculator to perform arithmetic operations or preset numbers to enter quantities into the Take Off Sheet data cells that are highlighted. The user can also enter data by obtaining information from a previous Take Off Sheet or by getting information from the last Take Off Sheet that was saved to memory. Items may be selected from a drop-down box of pre-defined items, by an autocomplete text entry method, typed in manually, or the like. To reduce errors in item selection and ensure accurate estimations, it is preferred that the user select the item from a predefined list. An example of a drop-down list of items is illustrated in FIG. 6. If a system and material have been loaded into supporting databases, once a specific system and material have been entered onto the Take Off Sheet, the program can pre-load the Take Off Sheet with predefined items and the sizes and quantities of the items that are commonly used for the system or have been specifically selected for the particular project being estimated. Each item also may have materials or requirements information associated with it that can be included automatically in the estimate when it is finally calculated, such as required joining materials, welds, hangers, supports, couplings, or any other material or item in the databases. To aid the user in ensuring that the correct item is selected, a box adjacent to the item column may be depressed to display a picture of the item on the screen (See box immediately to the left of each item row, FIG. 5) and can also include dimensions and physical data associated with the item. An example of such a picture is illustrated in FIG. 7.

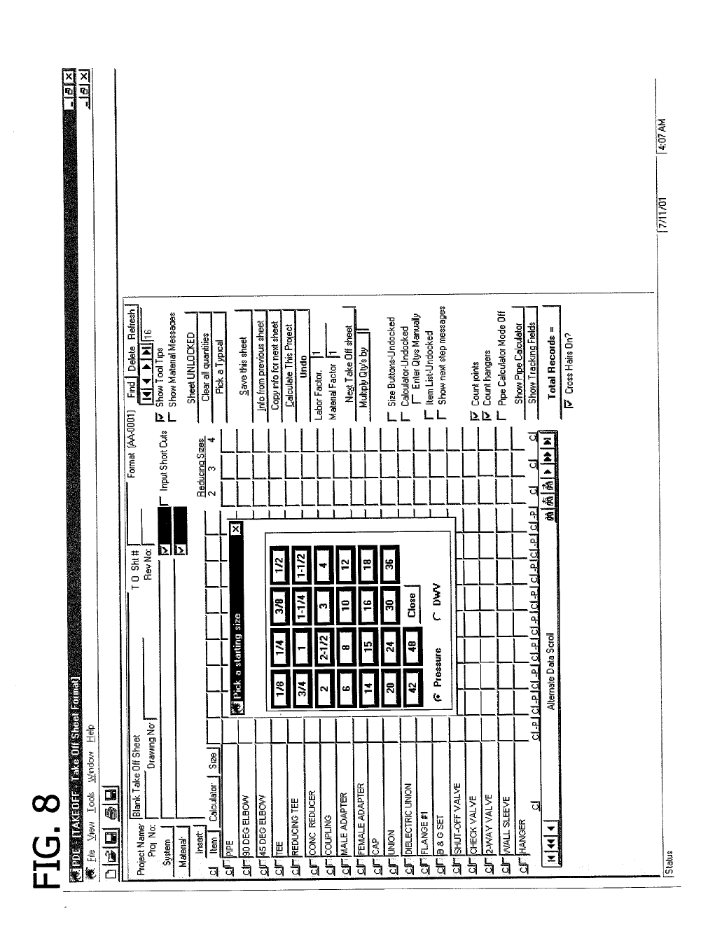

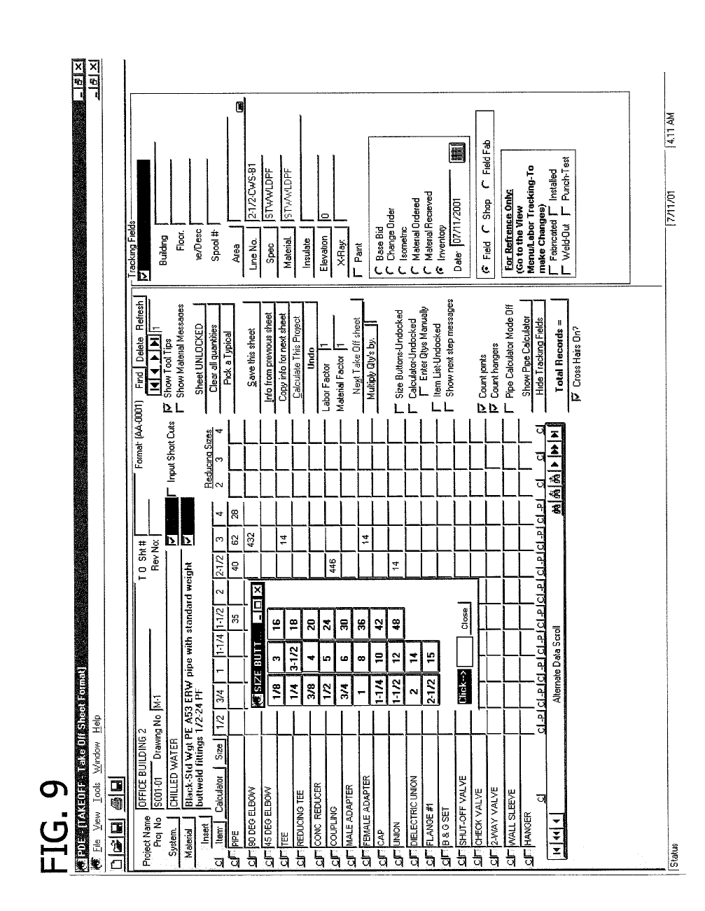

At step 324, the user may enter the quantities of items needed according to the size of each. For example, various sizes associated with a given item may be presented in column headings of the Take Off Sheet as illustrated in FIG. 5. The sizes may be listed across the columns in incremental order, in varying sizes, or some other order. The user may select a starting size from which the size columns incrementally increase by selecting a starting size button from the “Pick a Starting Size” window which can be defined by the user. An example of this is illustrated in FIG. 8. Alternatively, a specific column size may also be edited by clicking on the column size cell and entering a new size by manually typing the new size or by selecting the new size from a size window. An alternative means to manually entering the sizes is through a size window in which the user can select pre-determined sizes by simply depressing a size button on the size window to assign a size to a column of the Take Off Sheet, or pick a size from a size list. The size window is illustrated in FIG. 9. Another feature of the size buttons is the ability to see what sizes are available for a certain item picked when an “Available Sizes” button is selected and show what sizes exist in pricing databases. This helps the user know whether an item is in the pricing databases. Non-manufactured sizes may be pre-defined for each defined item listed such that a data entry cell corresponding to a non-manufactured item size can be “blacked-out” on the Take Off Sheet. The “blacked-out” cells thereby aid the user in avoiding selecting unavailable item sizes in an estimate.

Pre-loaded size and quantity values for listed items may be edited as required. If the item quantity values entered by the user or pre-loaded by the program are not desired, the user can remove all quantities by using a “clear all quantities” button. Similarly, if only a single column of sizes or row of items is desired to be cleared, a clear button adjacent to the column or row (as illustrated by the “C” button on FIG. 5) may be pressed to clear the information from the Take Off Sheet. Furthermore, as all quantities except for the length of pipe may often need to be revised, the “-P” button at the bottom of each column may be pressed to clear all quantities except for those pre-loaded for the pipe.

A user may utilize a calculator to select quantities into the Take Off Sheet by depressing a button having a predetermined number, manually enter a specific number, or calculate quantities and enter the quantities into a data cell. Additionally, a selected quantity may be manipulated by the arithmetic functions thereby permitting the user to easily increase the estimated quantities for multiple systems by adding or multiplying the quantities or decreasing the quantities through subtraction and division function buttons. If a quantity is already listed on the Take Off Sheet and the user simply wants to add a quantity to the listed number, the “accumulate numbers” function may be selected on the calculator in order to add the listed quantity with the additional quantity selected by the user on the calculator. A single quantity may also be entered into multiple data cells by selecting a multiple cells check box on the calculator and then selecting any quantity of data cells in the Take Off Sheet format input screen. As a quantity data cell is selected, the value selected on the calculator is entered into or added to the quantity data cells until the multiple cells feature is unchecked. The calculator is illustrated in FIG. 10.

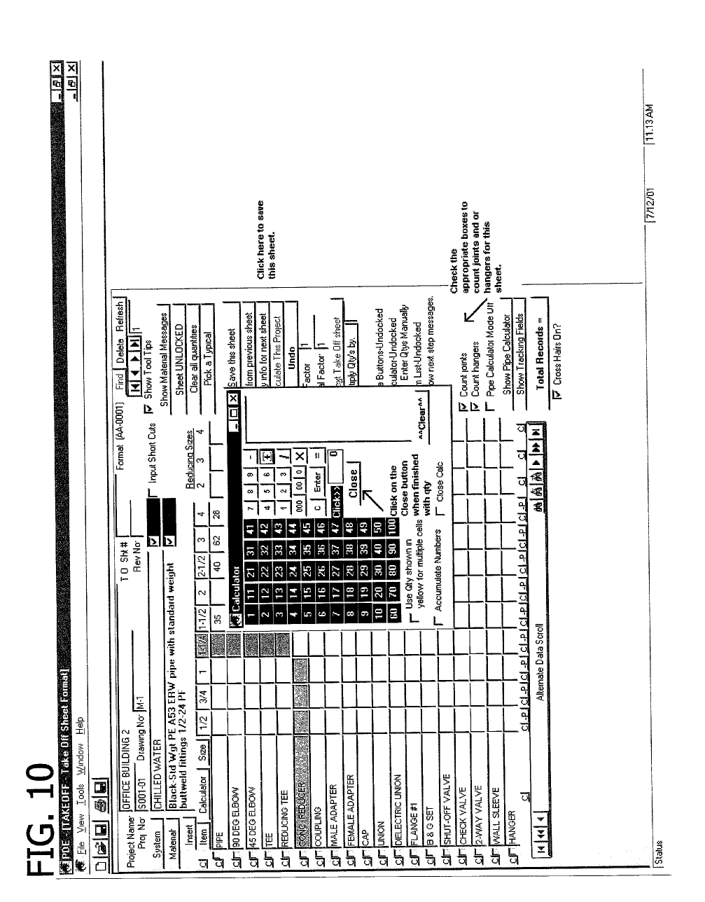

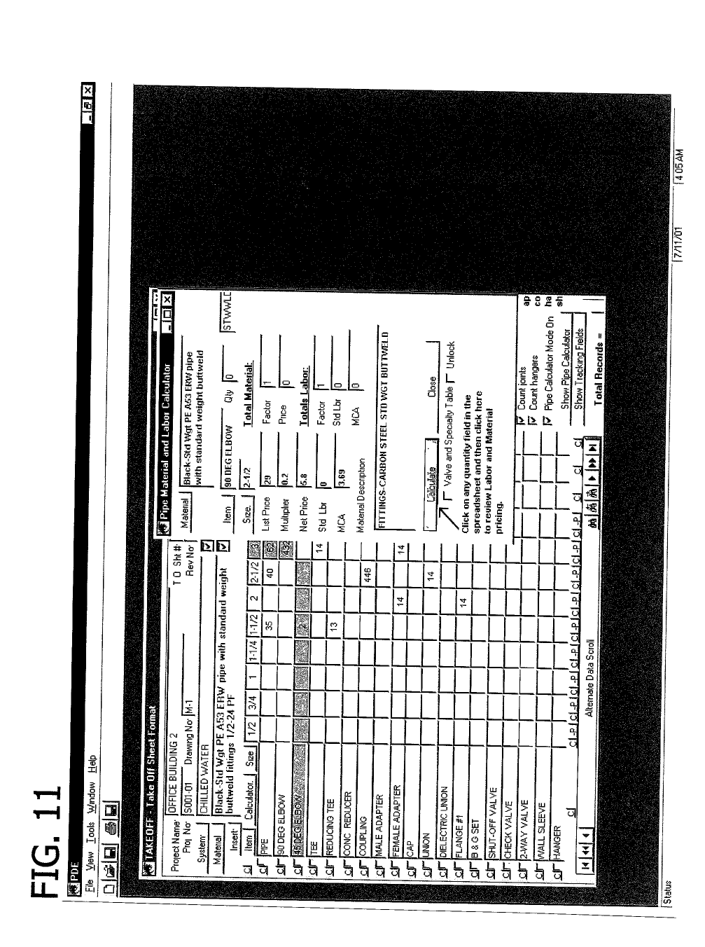

Another feature of the Take Off Sheet format is a Piping Calculator that allows the user to mouse click on any data cell on the Take Off Sheet input screen and calculate the material and labor using pricing databases. The piping calculator is illustrated in FIG. 11.

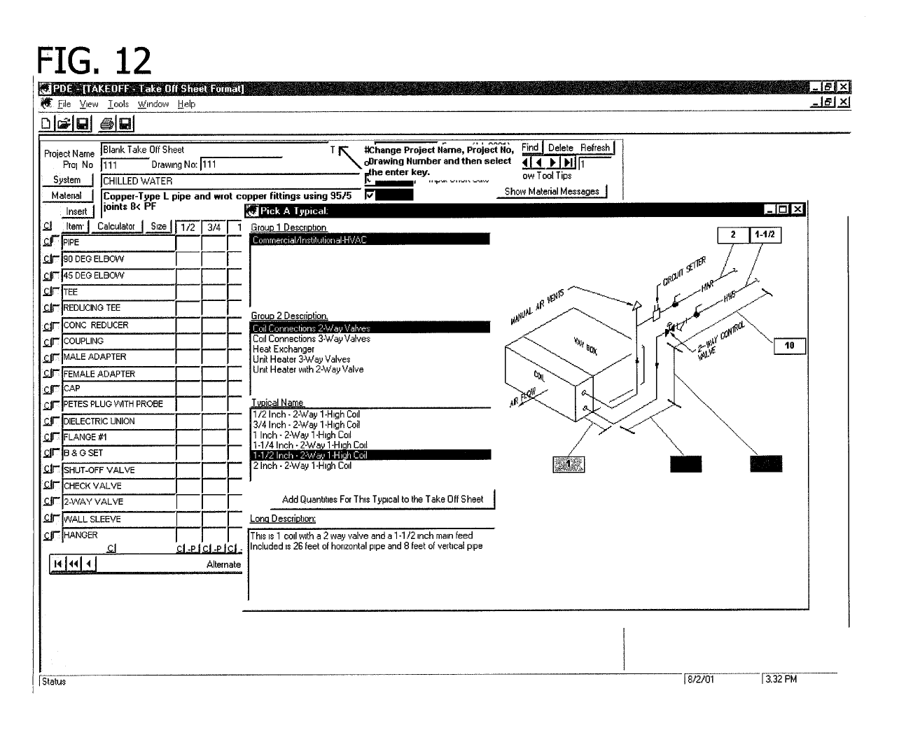

In a further aid for identifying and entering specific quantities of items on the Take Off Sheet, a user may select a “Typical” by depressing the “Pick a Typical” button illustrated in FIG. 5. Typicals are groups of items that are combined to attach a system to the main lines of construction (e.g., HVAC systems, electrical systems, piping systems, electrical systems, control devices, supports and structural steel systems, sheet metal and insulation systems, fire protection systems, industrial process systems, etc.). Thus, Typicals include fixtures, equipment, or structural steel supports and all of the associated hook-up materials necessary to attach the fixtures or equipment to the main line (e.g., piping, connectors, elbows, valves, reducers, electrical wiring, etc.). Examples of fixtures or equipment include HVAC equipment, chillers, hot-water heaters, structural steel supports and the like. The Typicals can be viewed by a user by selecting the desired Typical from a Typicals pull-down box which then displays the Typical on the screen as illustrated in FIG. 12. By viewing the Typical on the screen, the user can accurately identify and select the correct Typical fixture or equipment that is to be installed in the system.

When a Typical is selected, the items and their quantities are entered on the Take Off Sheet. If the user wishes to add the Typical quantities to the listed quantities that may already exist on the Take Off Sheet, the accumulate numbers function, similar to that of the calculator described above, will add the item quantities defined for the Typical to the listed quantities. In addition, a selected Typical may be predefined to include all the required hook up connections and lines to attach the Typical to the main lines of construction which can be added to the Take Off Sheet in one step. For example, in FIG. 12, if a “1½ inch-2-way 1-high coil” is needed in the installation of a commercial/institutional HVAC system, the Typical may be selected from the list of pre-defined Typicals. All the connections, including the equipment, lines, etc. required to hook the “1½ inch-2-way 1-high coil” to the main lines of construction can be added to the Take Off Sheet by depressing the “Add Quantities For This Typical to the Take Off Sheet” button. Thus, each piece of pipe, elbow, valve, equipment and so forth can be added to the estimate as a group and would not have to be individually entered on the Take Off Sheet. In addition, the listed Typical items may also be defined such that the associated materials or requirements such as joining materials, required welds, hangers, supports and any other data associated with the item are automatically added to the estimate when it is calculated.

The method of estimating pipe and fittings of the present invention is unique in that it graphically represents the equipment or fixture and associated hook-up materials and saves the graphic with all the information for a particular project. The user can also scroll through all the Typicals he has entered and saved for a particular project by using a data scroll or find button. The find button allows the user to look for Typicals by identification number and other searching parameters based on what has been input into the other text boxes. Saved Typicals may be retrieved and used as a template containing standardized sizes of hardware for Typicals that are repeated in projects, and quantities can be modified to adapt to each project's requirements.

In still another alternative to entering data into the Take Off Sheet, the required items and their quantities for a Typical may be created and saved as a pre-defined Typical for use in later estimates and/or be directly added to a Take Off Sheet in the same manner as previously described for adding pre-defined Typicals to a Take Off Sheet. Such a Typical may be an HVAC Typical, plumbing chase Typical, electrical Typical, structural steel support, or any other piece of equipment or fixture installed in construction projects as described in the Typical Builder Application section below.

After all the items and their corresponding quantities have been entered in the Take Off Sheet, the user instructs the program to save the information at step 326. At step 328, the data entered is checked to determine whether the minimum required data fields were completed. If the minimum data fields were not completed, at step 330 the user is required to complete the minimum fields. The process loops back to step 328 to verify if all of the required data fields were entered. If all required data fields have been completed, the process proceeds to step 332 wherein the information is stored to memory such as estimating database 218 and project specific databases. The information may be stored to local memory such as a hard drive, diskette, compact disk, or other local storage medium, or stored to remote memory such as a remote server database.

At step 334, it is determined whether the user wants to calculate an estimate for the input data. If the user selects to calculate an estimate, the data entered on the Take Off Sheet (i.e., the selected items and their quantities) and the materials or requirements associated with the selected items such as joining materials, required welds, hangers, supports and any other data associated with an item are totaled. The material and labor costs and other information are retrieved from pricing databases and a cost estimate is produced at step 338. Factors such as projects scheduled to start in the future may also be used to adjust the cost estimate (e.g., material costs for projects scheduled in the future may be estimated to cost more than if they were scheduled to begin immediately). Thus, the user may manipulate project dates to revise factors such as material and labor cost escalation factors. At step 340, it is determined whether a report is to be created for the calculated estimate. If no report is to be created, the process proceeds to step 346. If the user wishes to create a report, at step 342, the user selects a report from a list of pre-defined reports and selects whether the report should be printed to screen, to a printer, to a file, or to another output device. Tracking fields, such as drawing number, system number and so forth, may be used to allow reports to be generated and data to be grouped together. Once a user selects a report, a print utility permits the user to further define reporting criteria by a tracking field, such as an individual drawing number, building, etc. User defined reports may be created or saved to the reports database. At step 344, the selected report is created. The reports may be sent to an output device such as a printer, a computer display screen, an export file, and the like. The reports may also be saved to a database. Additionally, reports may be electronically sent over network 106 to customer 118 via export files, email, facsimile, and so forth. The process proceeds to step 346.

At step 346, if additional data is to be entered, the process loops back to step 315, otherwise, if no other data is to be entered, the estimating file may be saved to storage device as an individual file and process ends at step 348.

The Take Off Sheet entry screen provides a user with a number of options in preparing an estimate in addition to those briefly described above. Some of these options, as illustrated in FIG. 5, include but are not limited to:

(a) A “Sheet Locked/Unlocked” feature that locks everything on the screen so that existing information cannot be accidentally changed. An error dialog appears and gives you a choice to lock or unlock the screen.

(b) A “Save This Sheet” button feature will save the information displayed on the Take Off Sheet input screen and any associated item to an estimating database in the project specific database. Before the information is saved to the estimating database, the database is searched for existing data that matches the record number of the Take Off Sheet and overwrites the matching record. This ensures that any changed data will be deleted and recommitted before labor units, material units and other units of measure are applied as in paragraph (e) below.

(c) A “Get Info from Previous Sheet” button feature will copy all the information from the last saved sheet as in step (b) above, or will get all the information saved to memory as in step (d) below and copy that information into the current Take Off Sheet input screen.

(d) A “Copy Info Shown for Next Sheet” button feature will save the information on the current Take Off Sheet to memory and allow the user to utilize the information for another sheet.

(e) A “Calculate This Project” button feature will perform several procedural steps at once. If the “Automatically Count Joints” option is checked, the program will insert related items, such as welds for welded pipe and gaskets, fittings, and so forth into estimating database 218. Other items, such as pipe, fittings, valves can be set up by the user to count and insert other items into the estimating database of the project specific database. For example, some such items can be counted and inserted when a related item is selected (e.g., 2 flanges, 2 bolt and gasket sets, and 2 welds can be counted and inserted for every flanged valve that is found in the estimating database).

After the “Calculate This Project” button has been selected, all labor units, material units and other units of measure in the pricing databases are determined and calculated for each item in the Take Off Table. After these units have been determined, the Print Utility Screen appears as shown in FIG. 11 and allows the user to choose and print reports. The total material costs and labor hours are calculated from the input data at the time the reports are generated and multiple pricing and labor units may be applied at report time.

(f) A “Labor Factor” feature allows the user to apply the labor factor to all of the items on the sheet and applies that factor to the labor units at report time. The Labor Factor of a project is based upon the difficulty of the construction project being estimated. A default of “1” is used by the present invention unless changed by the user. If, for example, a particular job is located in a confined area thereby increasing the difficulty of a project, the Labor Factor can be increased accordingly to estimate higher labor costs resulting from the increased labor hours required to complete the project.

(g) A “Material Escalation Factor” feature allows the user to apply a material factor to all of the items on the Take Off Sheet and applies that factor to the material units at report time. If the project is anticipated to begin in the near term, the default factor of “1” is used. However, if a project estimate is being created far in advance of the actual start of the project, or if the project is anticipated to be delayed, the Material Escalation Factor may be increased (e.g., from a default of “1” to “1.2”) to reflect an increase in material costs over time.

(h) A “Next Take Off Sheet” button feature brings up the next Take Off Sheet input screen to be input and copies information from the previous saved Take Off Sheet input screen as it pertains to a particular project such as the Project Name, Project Number, etc.

(i) A “Multiply All Quantities By:” button feature allows the user to enter an amount in the data box to the right of this button that causes all quantities on the Take Off Sheet to be multiplied by the amount entered.

(j) An “Enter Quantities Manually” check box feature allows the user to navigate around in the quantity data cells using the arrow keys, tab key and enter key rather than using a mouse-based point and click method of inputting data. Once the user is at a desired data cell, the numeric key pad can be used to enter quantities. If the user accidentally scrolls to the top, bottom, left, or right part of the quantity data cell area, an error dialog box appears and warns that the user has scrolled too far.

(k) An “Automatically Count Joints” check box feature allows related items to be included in an estimate when specific items are selected based on criteria set up by the user. Thus, a gasket which is always used in connection with a flange can be automatically included in the estimate when the flange is selected. The items are then added into the estimating database and included in the total scope of the project when the “Calculate this Project” button is selected.

(l) An “Automatically Count Hangers” check box feature allows hangers to be attached to piping items based on criteria set up by the software administrator. These hangers are then added into the estimating database and included in the total scope of the project when the “Calculate this Project” button is selected.

(m) A “Pipe Calculator Mode On/Off” check box feature allows the user to look up material units and labor units for any item selected in the Take Off Sheet and perform calculations on that selected item.

(n) The “C” button feature adjacent to an identified item or column will clear all information contained in a row or column of a Take Off Sheet input screen.

Typical Builder Applications

The present invention also includes a method to generate Typicals that may be added to a Take Off Sheet during an estimate.

As described above, a Typical is a group of items and item quantities that are required to completely install a system, particular piece of equipment or fixture to a main line in a construction project. A main line may be a plumbing line, ventilation connection, electrical junction, and the like in a construction project. Examples of installed systems or particular pieces of equipment or fixtures include, but are not limited to, chillers, hot-water heaters, plumbing fixtures, electrical heaters, industrial pumps, and the like. For example, a Typical for a hot water heater would include the items of a hot water heater, piping for providing incoming water from a main water line to the hot water heater, piping for providing outgoing, heated water to the main line, and all the valves, connectors, hangers, elbows, fittings, and the like required to completely install the Typical. In addition, a Typical provides a graphical representation of the Typical connection (e.g., the schematic identifying all the parts of the Typical) to permit an estimator to accurately estimate all the pieces required for installing a complete Typical.

In a preferred embodiment, three interrelated Typical methods are utilized to aid the user in building a Typical, grouping Typicals together, and permitting the selection, use, and/or modification of pre-defined Typicals. These programs include: the Typical Image and Attribute Builder, the Typical Component Coupler and Typical Builder Items. The Typical Builder Items can be used by itself without sizes and length attributes or in conjunction with Typical Image and Attribute Builder or Typical Component Coupler. To create a Typical, the method relies upon a computer having a display screen, stored executable instructions, an input device and a processing unit coupled to the display screen, data storage device and the entry device.

Typical Image and Attribute Builder

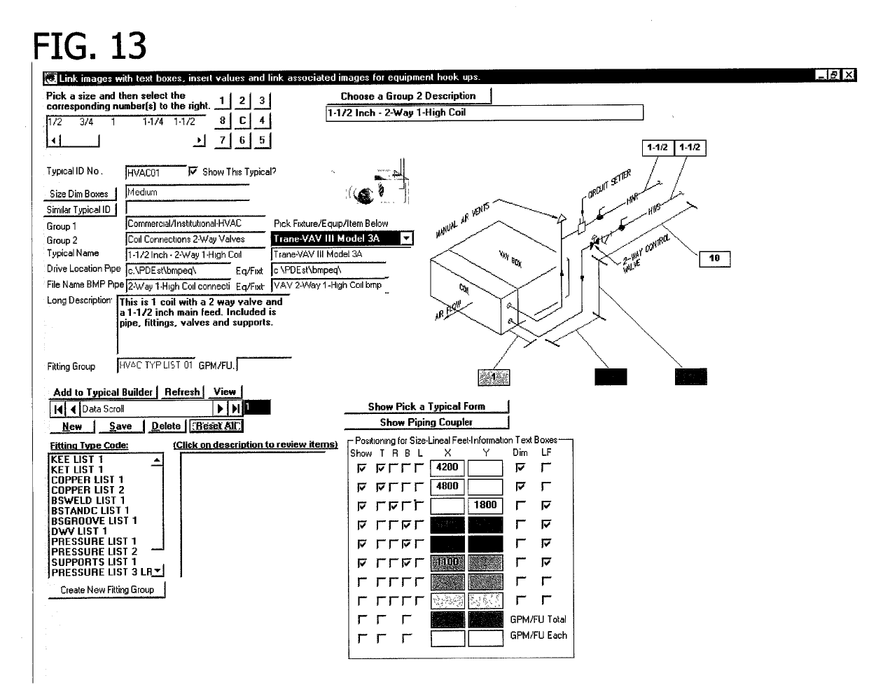

The Typical Image and Attribute Builder works in conjunction with the Typical Builder Items and the Typical Component Coupler. The Typical Image and Attribute Builder of the present invention allows a user to create and store information in a file or database which includes graphical images, text fields for dimensions and lengths of pipe, ductwork, etc. (the attributes), X and Y coordinates for the size and lineal feet data boxes, and all the items needed to install a Typical. The user can define or “build” a Typical by selecting a graphical image of a particular piece of equipment or fixture that will appear on screen and identify or map the location where dimension and length data boxes are placed around or on the graphical image. The graphical image is displayed on the screen after it is chosen from the pull-down box, selected from a graphical image database, scanned, or generated by the user. The user may also import and save his own pictures of equipment that are used to identify a defined Typical. FIG. 13 illustrates a Computer-Aided Design graphical image of a HVAC Typical being defined in the Typical Image and Attribute Builder of the present invention. The fixture that is included in a plumbing Typical may be defined in the Typical Image and Attribute Builder or the Typical Component Coupler as described below. Lead lines may be preferably provided on the graphical image that connect the data boxes to the piece of pipe or other item being defined.

Once a graphical image of the Typical is selected and the data boxes are located around or on the graphical image, the user chooses dimensions and lengths for the Typical from a size list and enters the dimension and length values of pipe, ductwork, conduit, etc. into the data boxes around the graphical image. An error message may be displayed if the user tries to enter a dimension into a lineal foot data box. In the same manner, if the Typical is for electrical equipment, the gage and voltage/amperage rating of electrical wiring may alternatively be entered in the data boxes.

The other items that are to be included for the Typical (e.g., valves, connectors, hangers, elbows, fittings, junction boxes, and the like may selected from a pull-down box listing the items, by manually typing the item name, or otherwise selecting the item. The sizes and quantities of the selected items are then defined for the Typical. Other parameters in a Typical definition may include, but are not limited to, the quantity of how many multiples of item sizes and quantities are to be included if a Typical includes more than one group of the items and quantity of items that was just defined, an identification number, drawing number, construction area, etc. Once the Typical has been built, the defined Typical (i.e., the graphical image and associated data boxes, and other associated items and their attributes) is stored in a file or database for later retrieval. The file or database may contain stored Typicals only or it may be a combined file or database containing stored Typicals and other data such as individual items, materials pricing, and the like.

Typicals may also be created to provide a graphical illustration of the fixture or equipment without the surrounding data boxes. In such a case, the dimensions and lengths of all the items are defined and saved to the Typical database, but are not displayed on the graphical illustration.

The Typical Image and Attribute Builder may also be used to build pictures of a Typical and define the requirements for fixtures and equipment. In the case of plumbing estimates, there are a myriad of configurations that piping in chases can be designed and connected to plumbing fixtures. The present invention provides systems and methods which assist a plumbing contractor and plumbing designer in determining the size of pipes, total fixture units and quantity of items for plumbing fixtures, equipment and foundry according to building codes, plumbing codes, engineering codes, and governmental codes. In addition, the configuration of fixtures and piping are graphically displayed and the total quantity of items required for the piping to these fixtures, equipment, foundry or miscellaneous labor operations are stored in a database.

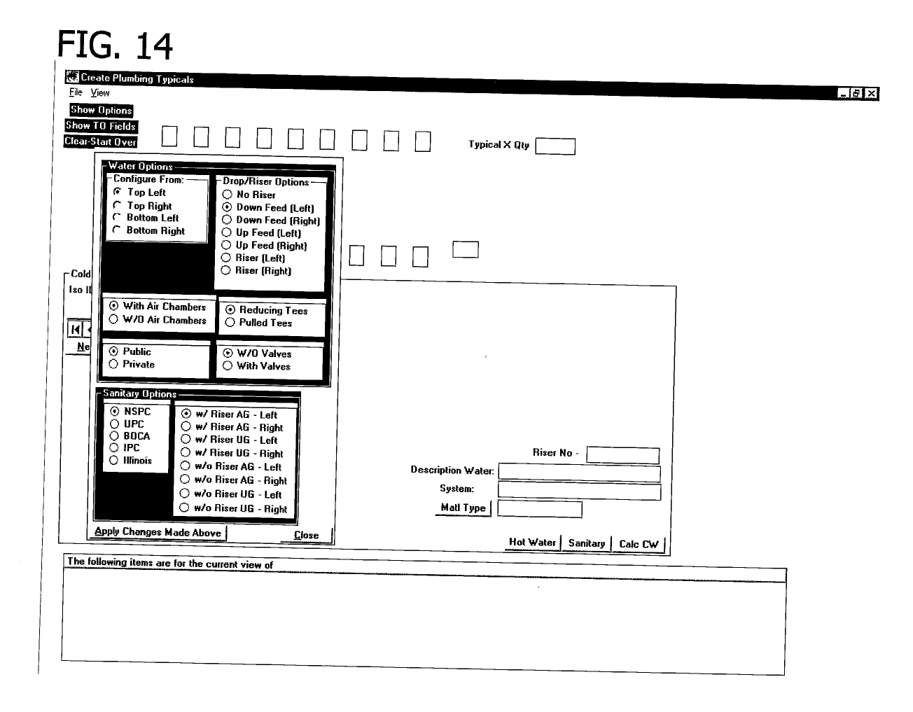

As described above, the user can choose individual pictures of fixtures and pipe. The selection may be conducted by selecting from a drop-down box, manually typing the file name, selecting the picture from a file or database, and the like. Alternatively, the Typical Image and Attribute Builder can allow the user to choose fixtures by selecting boxes or pictures of fixtures on the screen and “build” the graphical image. For example, a selection box may be structured to first display a picture of a flush valve water closet fixture. If the selection box is selected again, by clicking the box with a computer mouse, trackpad, and the like, the box then displays a picture of a sink fixture. If selected yet again, it displays a urinal this process continues each time the user clicks on the same box until the desired fixture appears or the picture loop back to the first displayed picture. The user selects the type of Typical that is being defined from an Options window (See FIG. 14). These parameters will affect the type of pictures that appear, the quantity of items such as pipe, fittings and valves, and the sizing of the mains determined by local and state codes chosen. Based on piping configurations selected in the Options and code requirements databases and the sizes of the pipe available in the items databases, the program will load the correct item or items and their respective quantities, dimensions, and lengths as each fixture or piece of equipment is selected. The Typical Image and Attribute Builder may also display the cold water (CW), hot water (HW) and sanitary waste and vent (SWV) piping information required to install the fixture shown, based on options chosen. Once the user is finished with the layout, the information may be saved to Typicals Database 214. The user can also directly add the quantities associated with the plumbing Typical to an existing Take Off Sheet or to a new blank Take Off Sheet as described above by choosing the Pick a Typical button and selecting the plumbing Typical ID from the list or selecting the Typical from a Typical Menu. Type of material, additions, and modifications to the quantities and items can be made and additional information about the items can be added such as Building, Floor, Area, etc.

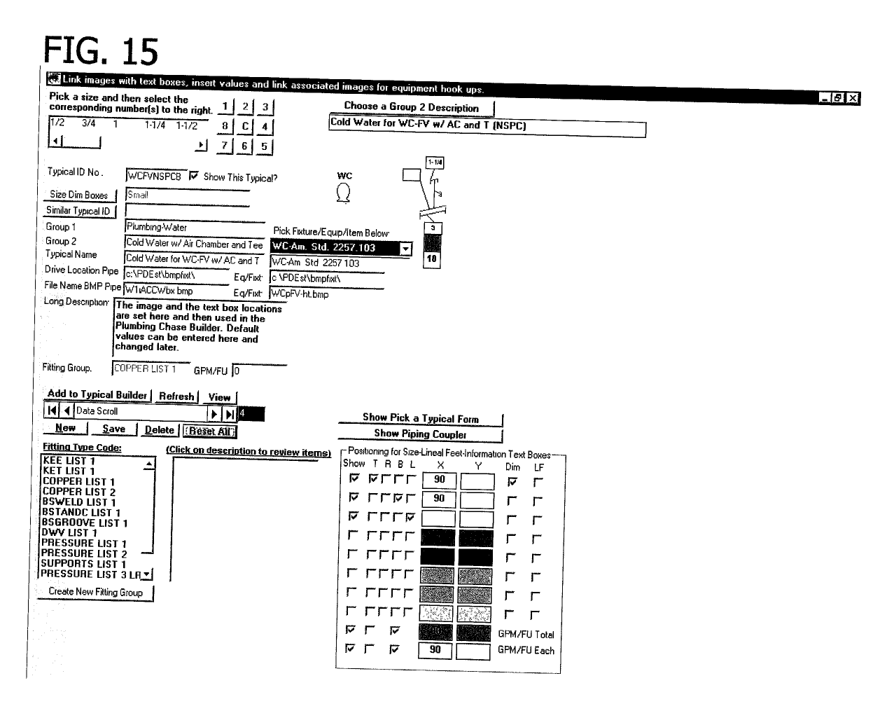

FIG. 15 is an exemplary screen display of the Typical Image and Attribute Builder screen that illustrates the creation of a plumbing Typical. When a user clicks on a rectangular box or square the type of plumbing fixture shown changes until the user finds the fixture desired. At the same time a fixture is selected, the cold water piping similar to the piping may be shown in a color (e.g., blue) connected to the selected plumbing fixture. An example of this is illustrated in FIG. 15. The hot water piping similarly may be shown in a different color (e.g., red), and the sanitary piping similarly may be shown in yet another color (e.g., black). Sizes and lineal feet quantities can be added or changed in any of the data boxes shown with leaders pointing to the items in each Typical.

Some of the advantages of the present invention over other programs include allowing the user to quickly visualize, size, and add quantities. The Typical Image and Attribute Builder feature thus allows the user to visually build, save, and automatically generate quantities of pipe, fittings, and other items based on what parameters are chosen.

If the user is building a new Typical, a Typical may be selected from pre-defined Typicals already stored in the file or database in order to insert similar hook-up materials, hook-up configurations, and attributes and then modify the pre-defined information. Using similar hook-ups versus starting from scratch each time would save time in the Typical building process.

The defined Typical may also be saved directly to a Take Off Sheet. If this is done, the defined items along with information about the Typical, sizes, and lengths, and other attributes are then added to the current Take Off Sheet that is being estimated. Thus, a Typical may be defined and saved on the Take Off Sheet for a current estimate and can also be saved in Typical Database 214 for use in a later estimate.

Additionally, a defined Typical can be added directly to the Takeoff Builder Items screen described below. This can be done by selecting a predefined button on the Typical Image and Attribute Builder such as the “Add to Typical Builder” button seen on FIGS. 13 and 15 or similar button or menu selection. If this is done, the defined items, along with information about the Typical, sizes and lengths are added to the Typical Builder Items screen. By saving the Typical to the Typical Builder Items, the user can scroll through the Typicals built for each project as well as add/modify the Typicals in the Typical Builder Items screen.

Typical Component Coupler

The Typical Component Coupler works in conjunction with the Typical Image and Attribute Builder and the Typical Builder Items to link pre-defined Typicals together. The Typical Component Coupler can design a layout, size the piping, and estimate quantities required to hook up fixtures, equipment and foundry. In this way a determination of what is required for each individual fixture is made versus looking at the whole amount of piping required for a riser diagram. In a sense it is like an electronic erector set that puts small pieces of the riser diagram together to make a whole riser diagram. Prior art deals with the riser diagrams as a whole and not as small pieces.

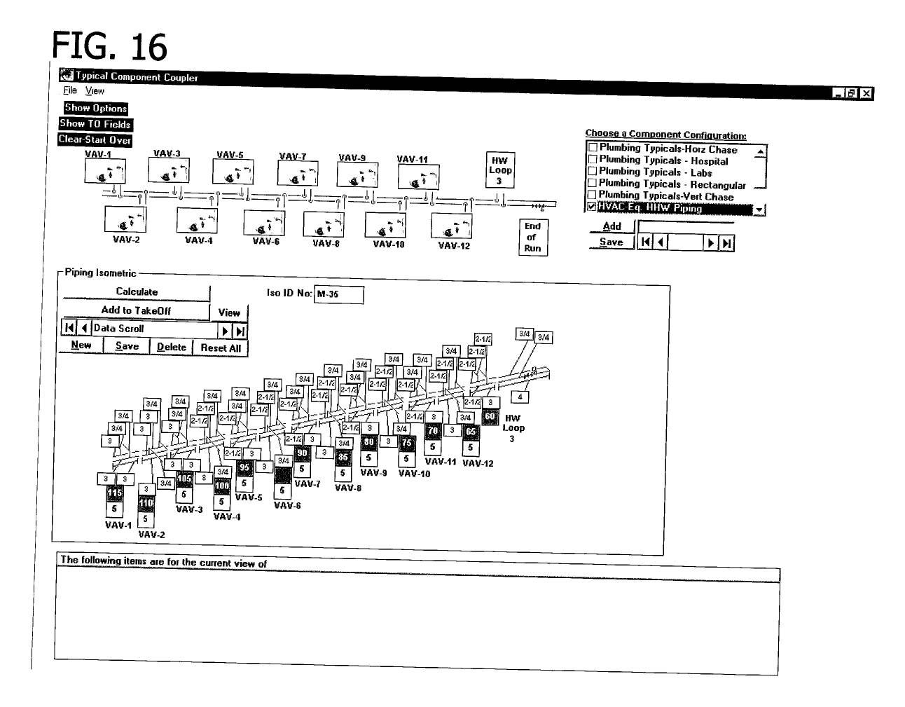

From a database containing Typicals, a user selects a Typical that is to be connected to one or more other Typicals. Once the Typicals that are to be connected have been selected, the program sizes and displays these Typicals on the screen based on parameters and Typical attributes that have been defined in either the Typical Image and Attribute Builder or the Typical Builder Items. When the final coupling of Typicals is complete, the coupling materials running between each Typical (e.g., pipe, connectors, elbows, electrical wiring, etc.) are automatically sized and selected from item databases when a calculate instruction is executed. Once the coupling calculations have been completed, the coupled Typicals may be saved to a file or the Typicals Database 214 as a single pre-defined Typical. An example of a coupled HVAC Typical is illustrated in FIG. 16.

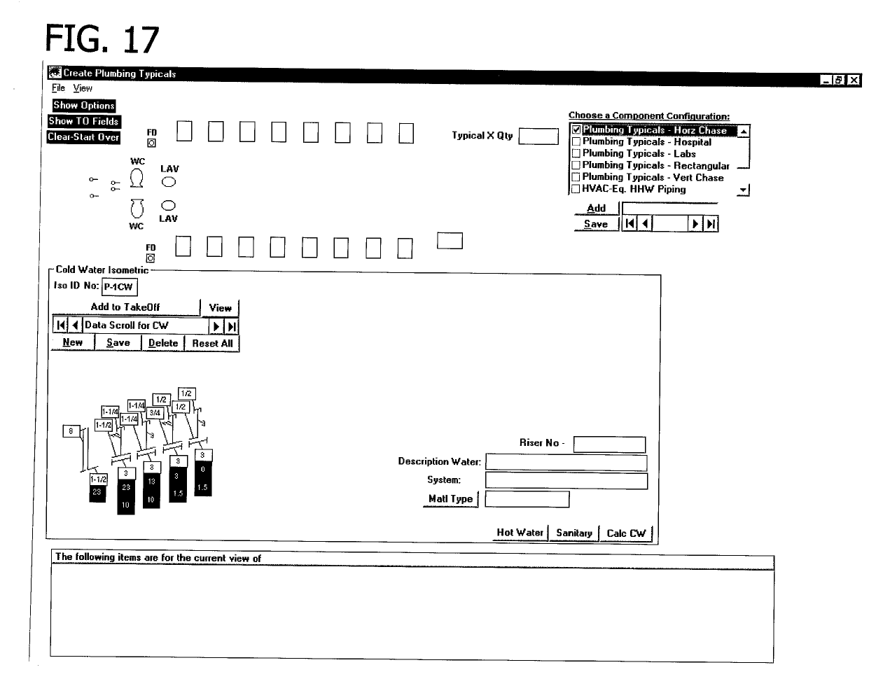

For example, if a user chooses a flush valve water closet in the Typical Component Coupler, the program will load the correct coupling component or components as each fixture or piece of equipment is selected from code databases and piping configurations based on the Options selected and items defined in the Typical Image and Attribute Builder (See FIG. 14). Selection of additional fixtures or equipment continues. When the user is done with the selections, a calculate instruction is given (e.g., the user selects a “calculate” button or menu item). The main piping that connects each fixture or piece of equipment together is sized and the unit of weight for each fixture or piece of equipment (Fixture Units, GPM, etc.) is totaled together based on code information (e.g., building codes, plumbing codes, engineering codes, and governmental codes) and items databases storing available sizes for the main piping, hook-up materials and coupling components. Once the selections and calculations are finished, the configuration of all the components shown on the screen can be saved in a file or database. The file or database used to store the configuration can contain pre-defined Typicals or also contain other data such as individual item information, material specifications, pricing, etc. An example of a plumbing Typical being coupled in the Typical Couplings Creator is illustrated in FIG. 17.

Although there are defaults for each component that is selected during the calculation of the component size, the calculated size of couplings can be overridden by the user by entering a size manually. If the value is manually entered, the remaining couplings are once again sized upon selection of a calculate instruction. The revised configuration of all the components shown on the screen can be saved to Typicals Database 214.

If the user chooses the “Add to Typical Builder Items” button, the items stored in the database (created with Typical Image and Attribute Builder) along with sizes and lengths of pipes calculated in the Typical Component Coupler are added to the Typical Builder Items screen for further additions and modifications. As in the Typical Image and Attribute Builder and the Typical Builder Items, each saved configuration is also available to the user when they choose Pick A Typical in the Take Off Screen.

In addition to its use in performing cost estimates of a construction project, the Typical Component Coupler can aid in the design of systems in which two or more fixtures or pieces of equipment are connected. The Typical Component Coupler can provide an automated method of designing and sizing connections between two or more pieces of equipment based on building codes, standard engineering practices and available sizes of coupling items.

Typical Builder Items

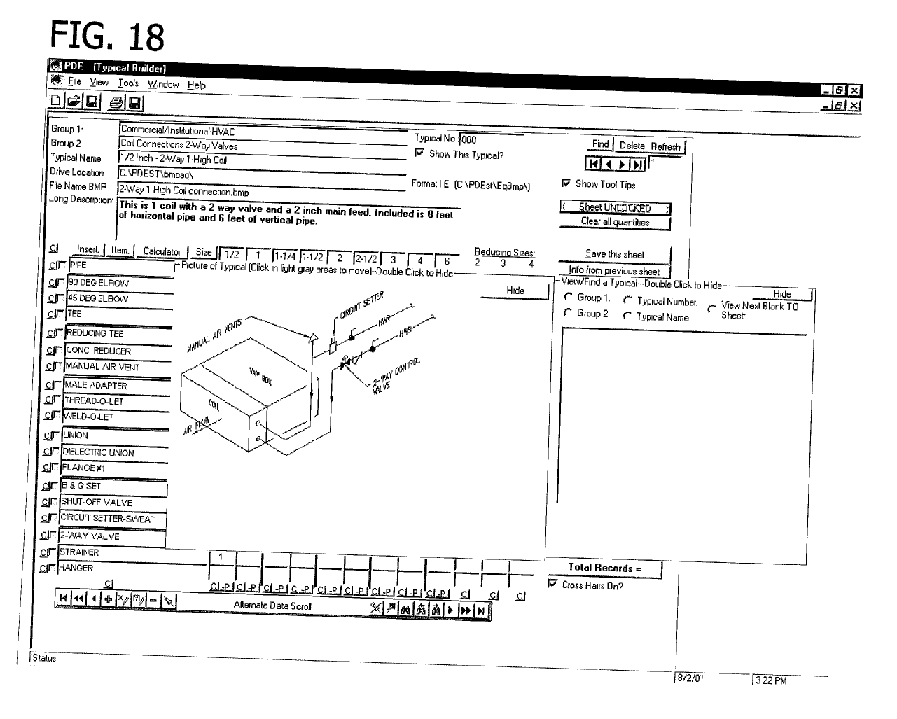

Typical Builder Items is a method that permits a user to either select a pre-defined Typical that is saved to memory and enter it on the Take Off Sheet or to modify a predefined Typical by identifying, adding, modifying, or deleting items or quantities thereof from a pre-defined Typical and saving it to Typicals Database 214. The Typical Builder Items may accessed from a button on the Take Off Sheet, a menu item that may be selected from the Take Off Sheet menu, an independent application, and the like. Once a Typical has been selected from the pre-defined Typicals or has been modified, it may be directly added to an active Take Off Sheet. If the Typical is modified by a user, once the Typical has been completed, it may be saved to the database of pre-defined Typicals or, alternatively, the Typical may also be directly entered onto an active data sheet. FIG. 18 illustrates a pre-defined Typical being displayed on the Typical Builder Items screen.

Pick a Typical

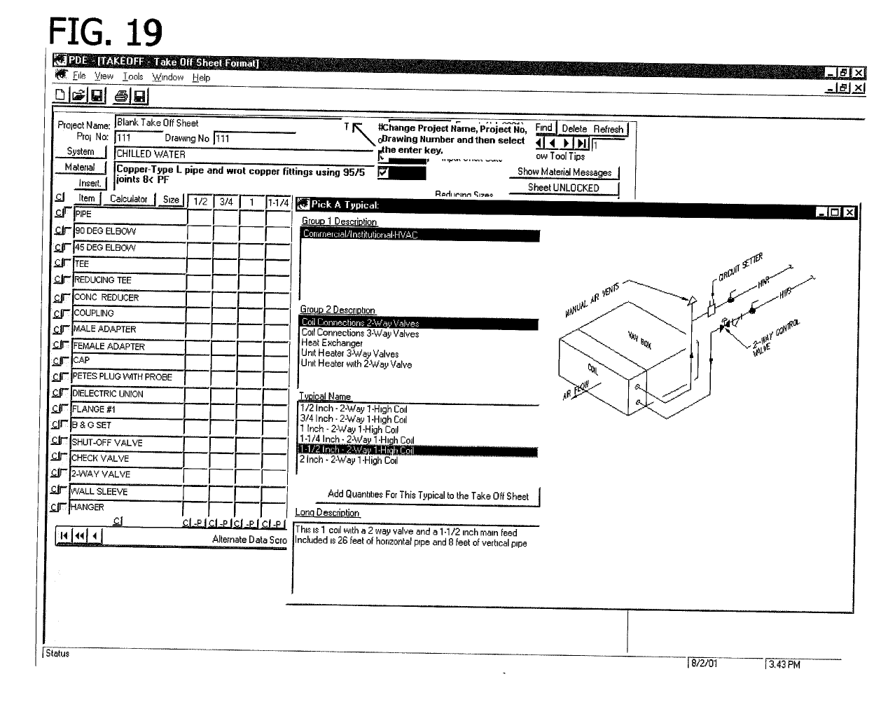

A Typical image along with the size boxes and length boxes can be viewed when the user selects a “Pick A Typical” button or menu item in the Take Off Sheet screen or in the Typical Builder Items screen. See FIG. 19. The user can enter all the items in the electronic Take Off Sheet required to install a Typical by selecting a button for Typicals (e.g., see FIG. 5, “Pick a Typical” button) selection from a Take Off Sheet menu, etc. and selecting a Typical from a Typical database or a list of Typicals. The quantities associated with the selected Typical can be added to an existing Take Off Sheet or to a new blank Take Off Sheet. The type of material and additions and modifications to these quantities and items can be made and additional information about these items can be added such as Building, Floor, Area, etc.

Pipe Calculator

FIG. 11 is an exemplary screen display showing the Pipe Calculator. This feature allows the user to pick any item on the Take Off Sheet entry screen that has corresponding pricing data in the pricing databases and perform calculations on the item that has no effect on any of the data for the project. This feature can also allow an administrator of the pricing databases to make changes to units (e.g., item cost, labor installation cost, etc.) in these databases without having to go anywhere else in the program.

This feature allows the user to quickly switch between materials and items in the pricing databases to find prices and labor units. By entering a quantity in the quantity data box of the piping calculator and choosing the calculate button material and labor can be calculated without setting up a project or inputting any data into the input screens or project specific database tables for a project.

Labor Tracking

The Labor Tracking feature allows the user to tag all items in the database to show progress on a project. While in the project tracking screen one can select a Line Number, Isometric Number or other fields that are associated with items. One can then choose Fabricated, Installed, Weld-Out, Punch, Test or some other tracking field tag. The tags (Fabricated, Installed, etc.) are applied to all the items associated with the Line Number, Isometric Number, etc. The report has formulas that detect which items are tagged and then multiplies the hours for each item by user defined percentages. This will indicate what percentage (Hours) of the project is complete and what percentage (Hours) is left to complete the project. For example, if certain items are tagged as Fabricated for Line Number CWR-001002-1-1/2 and in the user defined report 10% is used for any item tagged as fabricated then the unit hour for each item is multiplied by 0.1. If a 6″ Elbow=1.5 hours and it is checked as being being fabricated would be 1.5×0.1=0.15 hours completed. Therefore, it will still take 1.35 hours to Install it, Weld it out, Punch and Test it before the installation is complete.

Next Step Messages

FIG. 7 shows the Take Off Screen format and also shows a “Next Step Message” message and arrow that instructs the user to save the sheet and check function boxes as appropriate. The present invention provides Next Step Messages based on what options, material, and so forth are chosen and based on logic in the software in the form of executable instructions. The present invention also provides on-screen tools that permits users to utilize a format similar to a spreadsheet to pick items, sizes and quantities and speed up the input process. Preferably, one or two clicks of a mouse are needed to input data descriptions, numbers or variables. The Next Step Messages, in conjunction with the Take Off Sheet input screen, results in a shorter user learning curve for the program.

Replace Utility

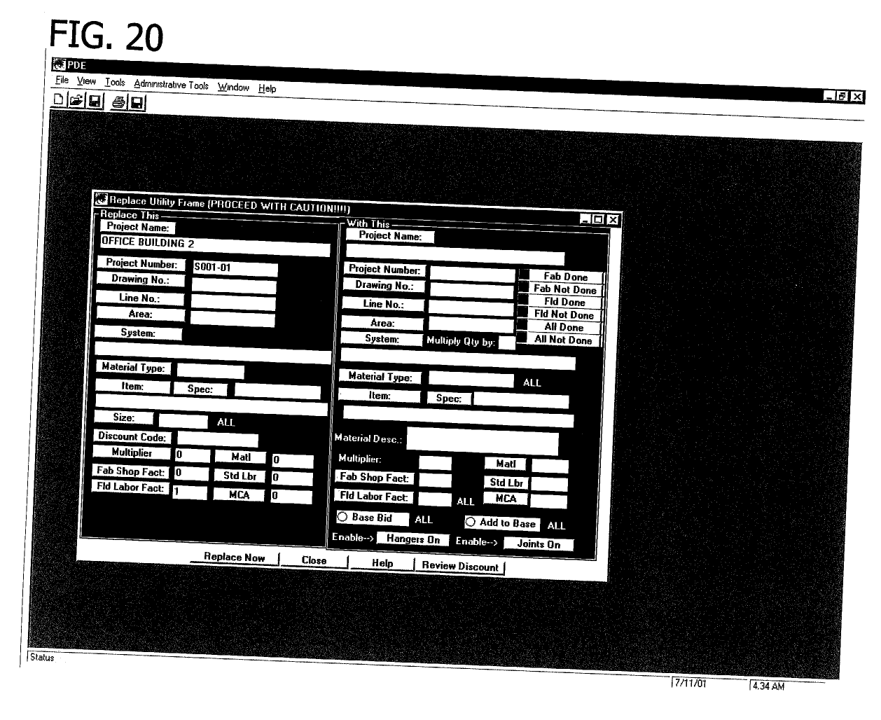

FIG. 20 is an exemplary screen display showing the Replace Utility that allows the user to change data such as Drawing Numbers, Items, Sizes, Change Material and Labor factors, Allow Labor Tracking and other fields to be manipulated. This identifies which construction systems (e.g., piping, electrical, etc.) have been completed on a project or the extent the overall project has been completed.

This feature allows the user to change the data by allowing the user to globally change or modify data in the project specific database without searching through the input screens or individual items.

Print Screen Utility

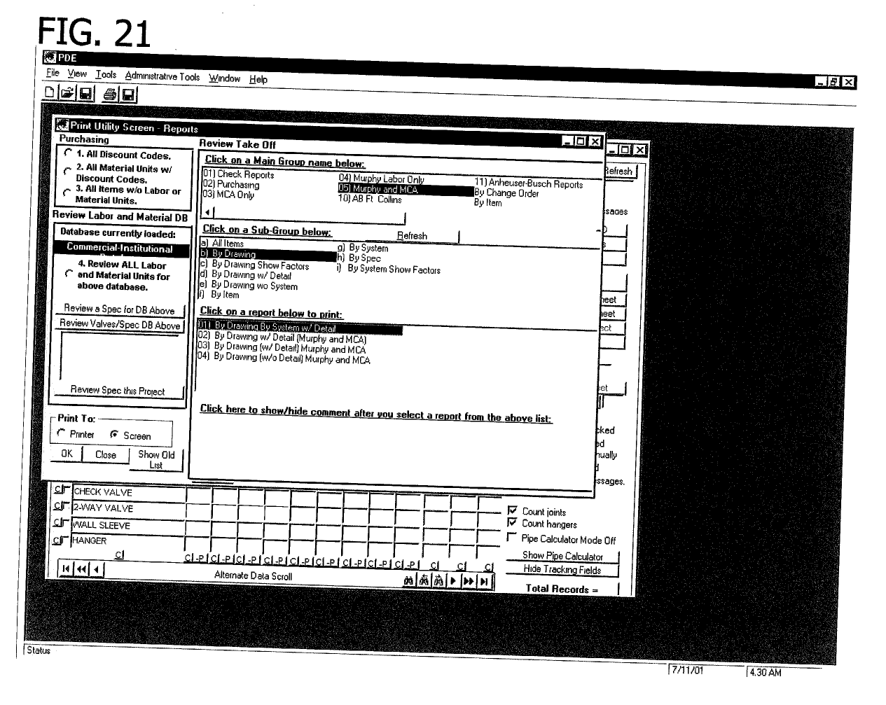

FIG. 21 is an exemplary screen display showing the Print Utility Screen. This feature allows the user to run standard reports for purchasing, to print or view what is in the pricing databases, and to run reports on criteria set up in the fields when the user enters the data in the input screen. When picking a report from the “Review Take Off” side of the Print Utility Screen, the user can pick from a project specific database to further narrow down the report to specific items or group of items as shown by the buttons that appear at the bottom of the screen. The captions and items to choose from at the bottom of the screen depend on what type of report is chosen by the user.

Pick Item List

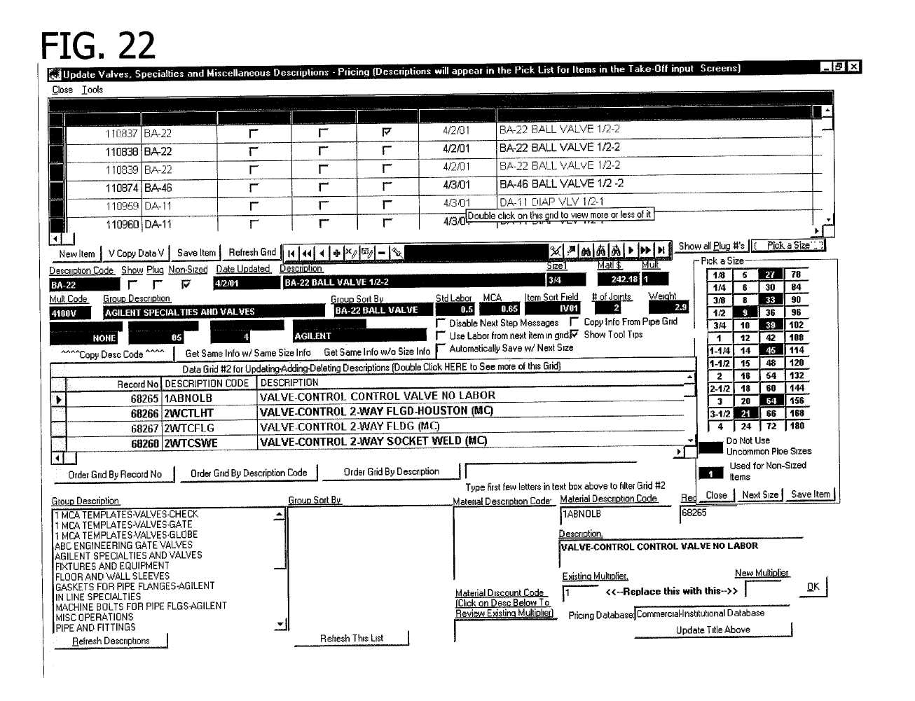

FIG. 6 is an exemplary screen display showing the Pick Item List that appears when the user clicks on an item text box shown on the left side of the screen shown in FIG. 5 of the Take Off Sheet input screen. The items shown and listed here are items in the pricing databases. These items can be changed and new items added using the updatable grids as shown in FIG. 22 and described below. This feature allows the user the ability to pick items set up by them in the pricing databases. “Updatable Grids” are also used to update and manipulate the Automatically Count Joints feature, the Automatically Count Hangers feature, and the information in the estimating database the project specific database.

Item Pricing Databases

FIG. 22 is an exemplary screen display showing an “Updatable Grid” that allows the user to add or change data in the pricing databases. When the user adds descriptions of an item, descriptions of groups, or changes data that are specific to the item, the program can attach units of measure, like prices, labor units, weights, etc. to items in a project that are entered into the Take Off Sheet input screen.

When the user clicks on the “Group Description: list” the “Group Sort By: list,” the grids are populated with items that match what was picked and the top grid is also filtered to the item picked in the Group Description: list.

As the user continues to choose from the “Group Sort By: list” and “Material Description Code: list” is populated with items that match what was chosen in the “Group Sort By: list.” Any item in the grids can be updated at any point in this process of selecting from the list. Data in the pricing databases can be updated by using this feature.

The updatable grid feature allows for plug numbers to be added during the bidding process of a project and by using the “Show all Plug #'s” button, the user can filter all items with plug numbers, change the pricing to what the actual cost is from the suppliers of those items and calculate a new total cost for the project.

This updatable grid also allows for a row or rows in the top grid to be highlighted and copied to the pricing database grid on the bottom by using the right mouse button to drag and copy the information. The descriptions of these items, Group Descriptions, Group Sort By: descriptions and other attributes of these new items can then be easily changed for any specifications for a project.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above compositions and processes without departing from the scope of the invention, it is intended that all matter contained in the above description be interpreted as illustrative and not in a limiting sense.

I claim:

1. A computerized method for estimating material and labor costs of a construction project comprising:
maintaining a first database of items and cost data associated with each of the items;
grouping one or more of the items from the first database to define predetermined sets of items, each of said predetermined sets of items corresponding to a desired installation of the grouped items;
selecting one or more of the sets of grouped items based on the construction project; and
calculating the estimated cost of the construction project based at least in part upon the cost data associated with the items in the selected set of grouped items.

2. The computerized method of claim 1 further comprising:
maintaining a second database of graphical representations, each of said graphical representations corresponding to one of the sets of grouped items; and
displaying the graphical representation of at least one set of grouped items upon selection.

3. The computerized method of claim 2 further comprising identifying sizes and quantities of the grouped items from the displayed graphical representation.

4. The computerized method of claim 2, wherein the the graphical representation of the grouped items is displayed and dimensions of hook-up materials are defined by entering dimension units of measure in data boxes associated with the graphical representation of the grouped items.

5. The computerized method of claim 1 wherein the grouped items are selected from the group consisting of heating, ventilation, and air conditioning equipment and associated hook-up materials; plumbing fixtures, equipment, foundry, structural supports, and associated hook-up materials; and electrical fixtures, equipment, and associated hook-up materials.

6. The computerized method of claim 5 wherein the length and size of associated hook-up materials are defined at the time the grouped items are selected.

7. The computerized method of claim 1, wherein the grouped items comprises at least two fixtures or equipment connected together with coupling materials.

8. The computerized method of claim 7, wherein the size of the coupling materials is calculated based at least in part upon stored building code and available coupling material size.

9. The computerized method of claim 8, wherein the calculated size of coupling materials may be manually overridden by a user.

10. In a computer system having a processor, a graphical user interface including a computer display, and an input device, a method for estimating material and labor costs of a construction project comprising:
maintaining a first database of items and cost data associated with each of the items;
grouping one or more of the items from the first database to define predetermined sets of grouped items, each of said predetermined sets of grouped items corresponding to a desired installation of the construction project;
displaying a Take Off Sheet data entry screen on the computer display comprising quantity data cells corresponding to item size;
entering one or more of the sets of grouped items onto said Take Off Sheet data entry screen based on the construction project; and
calculating the estimated cost of the construction project based at least in part upon the cost data associated with the items in the selected set of grouped items.

11. The method of claim 10, wherein the selected grouped items is selected from the group consisting of heating, ventilation, and air conditioning equipment and associated hook-up materials; plumbing fixtures, equipment, foundry, structural supports, and associated hook-up materials; electrical fixtures, equipment, and associated hook-up materials; industrial process equipment and associated hook-up materials; and fire protection equipment and associated hook-up materials.

12. The method of claim 11, wherein the set of grouped items are grouped together according to a graphical representation of the grouped items.

13. The method of 12, further comprising identifying sizes and quantities of the grouped items from the displayed graphical representation.

14. The method of claim 12, wherein dimensions of grouped items are identified on the graphical representation of the grouped items and stored to a database of pre-defined grouped items.

15. The method of 14, wherein the dimensions of hook-up materials are defined by entering dimension units of measure in data boxes associated with the graphical representation of the grouped items.

16. The method of claim 15, wherein the graphical representation of the grouped items is displayed to the computer display prior to being entered onto said Take Off Sheet data entry screen.

17. The method of claim 10, wherein the items comprising the pre-defined grouped items are modified prior to being entered onto said Take Off Sheet data entry screen.

18. The method of claim 17, wherein the modified grouped items are stored to the database of pre-defined grouped items.

19. The method of claim 12, wherein two or more sets of grouped items are combined to form a combined set of grouped items.

20. The method of claim 19, wherein dimensions of the combined set of grouped items are identified on the graphical representation of the combined grouped items and stored to a database of pre-defined grouped items.

21. The method of claim 19, wherein the sets of grouped items comprise at least two fixtures or equipment that are connected together with coupling materials.

22. The method of claim 19, wherein the coupling material size is calculated by the processor based at least in part according to code requirements.

23. The method of claim 22, wherein the code requirements are selected from the group consisting of building codes, plumbing codes, engineering codes, and governmental codes.

24. An automated system for estimating a cost of selected equipment for a construction project comprising:
a. an first database containing construction items and material and labor cost data associated with each of the items;
b. a second database containing one or more of the items from the first database that define predetermined sets of grouped items, each of said predetermined sets of grouped items corresponding to a desired installation of the grouped items in the construction project; and
c. a computer executing a cost estimating software program and accessing the second database for users to select grouped items, said cost estimating software program retrieving information from the second database, and providing a cost estimate of the construction project based at least in part upon the selected grouped items data.

25. The automated cost estimating system of claim 24 further comprising graphical illustrations of grouped items wherein the computer executing a cost estimating software program displays graphical illustrations of the selected grouped items.

26. The automated cost estimating system of claim 24 wherein the items and sets of grouped items are stored in a common database.

27. The automated cost estimating system of claim 24 wherein the software program provides a series of instructions that prompt a user to enter appropriate estimate data.

28. The automated cost estimating system of claim 24 wherein the software program estimates construction project costs for selected grouped items and hook-up materials and automatically includes associated equipment and hardware related to the selected grouped items and hook-up materials.

29. The automated cost estimating system of claim 28, wherein the associated equipment and hardware related to the selected grouped items and hook-up materials is defined by a user.

30. A computerized system for estimating the material and labor costs of a construction project comprising:
a remote server on a communications network managing software programs and databases;
a central database associated with the remote server, said central database storing construction material specifications and graphics, labor cost data, and material pricing data; and
a local computer on the communications network executing a material and labor cost estimating program, accessing data from the central database for use by the material and labor cost estimating program, and generating one or more reports for material and labor cost estimates for the construction project.
